(19) United States
(12) Patent Application Publication
(10) Pub. No.: US 2004/0066731 A1
(43) Pub. Date: Apr. 8, 2004

(54) Disk drive

(75) Inventor: Naohide Ota, Nagano (JP)

Correspondence Address: OLIFF & BERRIDGE, PLC, P.O. BOX 19928, ALEXANDRIA, VA, 22320, US

(73) Assignee: Shinano Kenshi Co., Ltd., Chiisagata-gun (JP)

(21) Appl. No.: 10/671,439

(22) Filed: Sep. 29, 2003

(30) Foreign Application Priority Data
Oct. 2, 2002 (JP) 2002-289409

(51) Int. Cl. G11B 23/00; G11B 25/00

(52) U.S. Cl. 369/263

(57) ABSTRACT

A disk drive includes a rotation drive mechanism that rotates a disk; an optical unit that records information on the disk and/or reproduces information therefrom; a moving mechanism that moves the optical unit; a chassis that supports the rotation drive mechanism, the optical unit and the moving mechanism; and a weight positioned opposite, via a rotational axis of the rotation drive mechanism, to an initial center-of-gravity position of the chassis that includes the rotation drive mechanism, the optical unit and the moving mechanism.

### BACKGROUND OF THE INVENTION

1. Field of the Invention

The present invention relates to a disk drive that reproduces information recorded on a disk-shaped recording medium (hereinafter simply referred to as disk) while the disk is being rotated, and records information thereon. More particularly, the present invention relates to a disk drive capable of effectively vibration that may be caused due to rotation of the disk-shaped recording medium.

2. Description of the Related Art

Conventionally, various types of disk drives are known. Examples of these disk drives are CD-ROM, CD-R, CD-RD and DVD drives. FIGS. 1A, 1B and 1C show an internal structure of a disk drive. More particularly, FIG. 1A is a plan view of the disk drive, FIG. 1B is a right side view thereof, and FIG. 1C is a left side view thereof.

Referring to these figures, a disk drive 100 is equipped with a rotation drive mechanism 110, which includes a turn table 111 that rotates a disk in a given direction while holding it. The disk drive 100 is also equipped with an optical pickup unit 120 that includes a lens 121. The optical pickup unit 120 serves as an optical device that reproduces information from the disk 1 and records information thereon. The optical pickup unit 120 can be moved to a given position on the disk by means of a moving mechanism 130 driven by a motor 131 serving as a drive source. In FIG. 1A, the optical pickup unit 120 is illustrated so that it is located at two end positions. The optical pickup unit 120 can be moved within a range W within which information can be recorded on and reproduced from the disk 1.

The rotation drive mechanism 110, the optical pickup unit 120 and the moving mechanism 130 that moves the pickup unit 120 are supported by a chassis 105 that has a given rigidity. The chassis 105 may be fixed to a casing via dumpers 115-1 through 115-4 for absorbing vibration.

If the disk has eccentricity in the center of gravity or distortion, the chassis 105 may be vibrated due to unbalance of rotation. Particularly, if specific kinds of chassis vibration increase, error may occur in retrieving and recording. Examples of such specific kinds of chassis vibration are a vibration in directions perpendicular to the disk surface and another vibration in the pickup moving directions.

With the above in mind, conventionally, a weight is placed on the chassis 105 to thereby restrain vibrations of the chassis 105. FIGS. 2A through 2D show a weight 140 that may be mounted on the chassis 105. More particularly, FIG. 2A is a plan view of the weight 140, and FIG. 2B is a right side view thereof, while FIG. 2C is a front view thereof, and FIG. 2D is a perspective view thereof. As shown in these figures, the weight 140 has a ring-like shape and a size mountable on the whole periphery of the chassis 105. The weight 140 may be made of the same material as that of the chassis 105, and may, for example, be a steel product. The weight 140 has bent portions that match the whole shape of the chassis 105, which are equipped with screw holes 141-1-141-4 by which the chassis 105 may be screwed.

FIG. 3 shows how the weight 140 is mounted on the disk drive 100. The weight 140 has a size that allows the weight 140 to be mounted on the whole periphery of the chassis 105 that supports the rotation driving mechanism 110, the optical pickup unit 120 and the moving mechanism 130. The weight 140 is screwed to the chassis 105. The arrangement of the weight 140 along the whole periphery of the chassis 105 is intended to improve vibration isolation by increasing the weight of the chassis 105.

Nowadays, it is strongly required to realize downsizing of devices. This may be achieved by improving the arrangement of components. For example, in the case of FIGS. 1A through 1C, the rotation drive mechanism 110 for rotating the disk 1 is positioned on an end side of the chassis 105.

As has been described, a certain vibration isolation effect is expected by increasing the weight of the chassis 105. However, once vibration occurs due to rotation of the disk 1, the increased weight of the chassis 105 may bring about an adverse effect. That is, energy obtained at the commencement of rotation with the weight 140 being added is greater than that in the absence thereof. Such large energy may result in vibration and noise that travels to the outside of the disk drive.

The conventional arrangement allows the position of the center of gravity of the chassis 105 that actually supports the rotation drive mechanism 110, the optical pickup unit 120 (defined as an initial center-of-gravity position) and so on to deviate from the center of rotation of the turn table 111. The recent disk drives rotate the disk 1 at a higher revolution to speed up reproduction and recording. Under these situations, it is very difficult to surely restrain vibration due to rotation of the disk 1 by merely increasing the weight of the entire chassis 105.

A heavier weight may be mounted on the chassis 105 for restraining vibration. However, the disk drive with a heavier weight is not resistant to falling vibration that may occur during transport. In addition, the transport cost and load on environment may increase.

Japanese Patent Application Publication No. 2002-170368 discloses a horseshoe substrate for vibration isolation. This substrate serves as a weight, and is arranged so that the center of gravity thereof is located on the rotational axis of a spindle motor. This arrangement brings about the uniform vibration isolation effect.

However, the art disclosed in the above publication does not consider the center of gravity of a drive substrate (mechanical chassis) that supports the spindle motor and the optical system. Therefore, satisfactory vibration isolation effect will not be expected unless the weight is much heavier than the mechanical chassis.

### SUMMARY OF THE INVENTION

It is a general object of the present invention to provide a disk drive in which the above disadvantages are eliminated.

A more specific object of the present invention is to provide a disk drive having an improved vibration isolation effect.

These objects of the present invention are achieved by a disk drive including; a rotation drive mechanism that rotates a disk; an optical unit that records information on the disk and/or reproduces information therefrom; a moving mechanism that moves the optical unit; a chassis that supports the rotation drive mechanism, the optical unit and the moving mechanism; and a weight positioned opposite, via a rotational axis of the rotation drive mechanism, to an initial center-of-gravity position of the chassis that includes the rotation drive mechanism, the optical unit and the moving mechanism.

### BRIEF DESCRIPTION OF THE DRAWINGS

Other objects, features and advantages of the present invention will become more apparent from the following detailed description when read in conjunction with the accompanying drawings, in which;

FIG. 1A is a plan view of a conventional disk drive;

FIG. 1B is a right side view of the disk drive shown in FIG. 1A;

FIG. 1C is a front view of the disk drive shown in FIG. 1A;

FIG. 2A is a plan view of a weight used in the conventional disk drive;

FIG. 2B is a right side view of the conventional disk drive;

FIG. 2C is a front view of the conventional disk drive;

FIG. 2D is a perspective view of the conventional disk drive;

FIG. 3 shows how the conventional weight is mounted on the disk drive;

FIG. 4A is a plan view of a weight used in a disk drive according to an embodiment of the present invention;

FIG. 4B is a right side view of the weight shown in FIG. 4A;

FIG. 4C is a front view of the weight shown in FIG. 4A;

FIG. 4D is a perspective view of the weight shown in FIG. 4A;

FIG. 5 shows how the weight of FIGS. 4A through 4D is installed in a disk drive main body; and

FIG. 6 shows the average values of embodiment and comparative disk devices in R, Z and J directions obtained from Tables 1 and 2 that will be described later.

### DESCRIPTION OF THE PREFERRED EMBODIMENT$

A description will be given of preferred embodiments of the present invention with reference to the accompanying drawings.

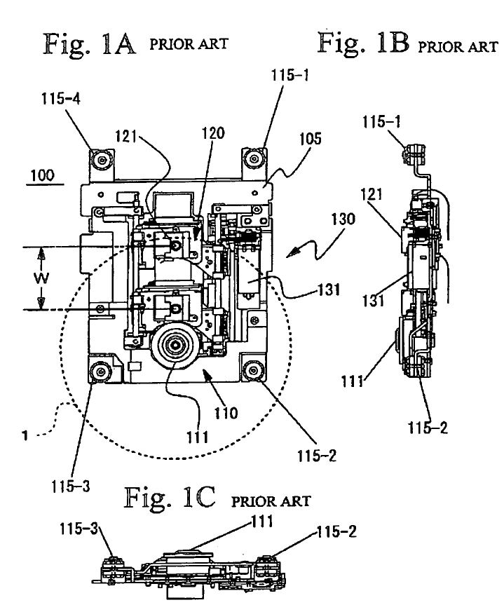

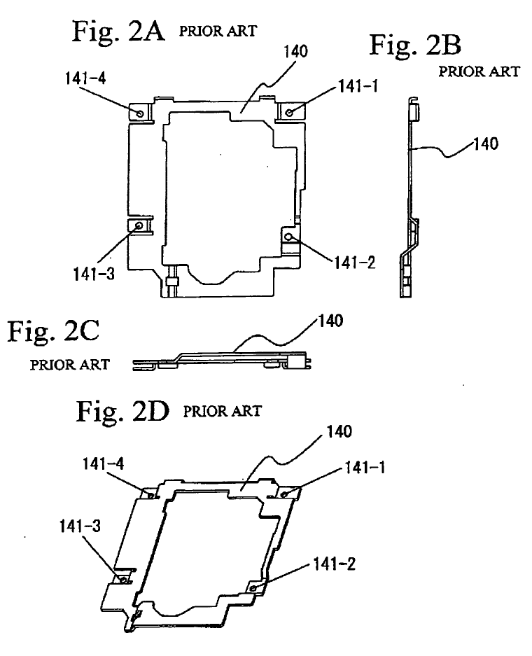

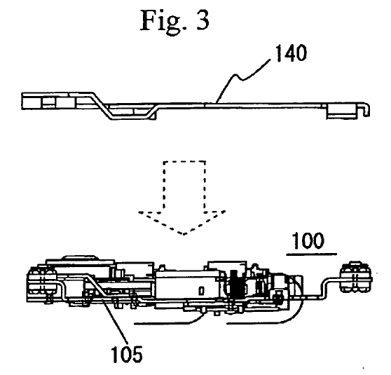

A disk drive according to an embodiment of the present invention employs the main body of the disk drive 100 shown in FIGS. 1A through 1C from which the weight 140 is removed. Therefore, components of the embodiment that are used in the disk drive 100 are given the same reference numerals in the following.

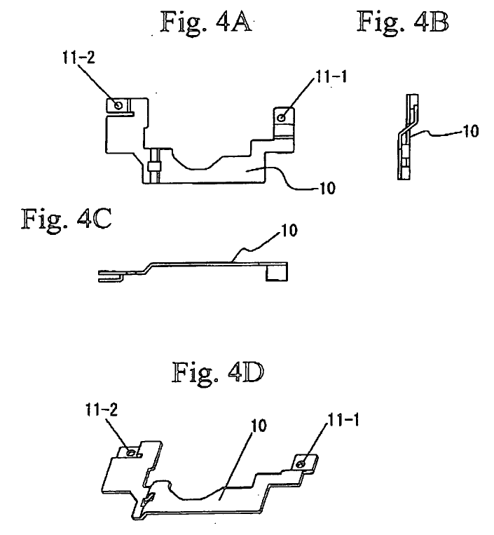

FIGS. 4A through 4D show a weight 10 used in the present embodiment. More particularly, FIG. 4A is a plan view of the weight 10, FIG. 4B is a right side view thereof, FIG. 4C is a front view thereof, and FIG. 4D is a perspective view thereof.

The weight 10 is comparatively compact and has an approximately C-shaped structure. The weight 10 is not mounted on the entire periphery of the chassis like the conventional weight 140, but is mounted on a part of the periphery of the chassis. The weight 10 may be made of the same material as the chassis. The weight 10 is bent so as to match the shape of the specific portion of the chassis on which the weight 10 is mounted. The weight 10 has screw holes 11 via which the weight 10 is screwed to the chassis. Since the weight 10 is compact, only two screw holes 11-1 and 11-2 are formed therein. This reduces the number of assembling steps. The weight 10 may be attached to the chassis 105 directly or via an interposing dumper.

As will be apparent from a description given later, the weight 10 is disposed so that the center of gravity of the chassis 105 with the weight 10 becomes close to the rotational center of the disk. That is, the weight 10 is not intended to merely increase the weight of the chassis but to shorten the distance between the rotational center of the disk that may be a source of vibration and the position of the center of gravity of the drive. For this purpose, the weight 10 is disposed to a part of the periphery of the rotation drive mechanism 110.

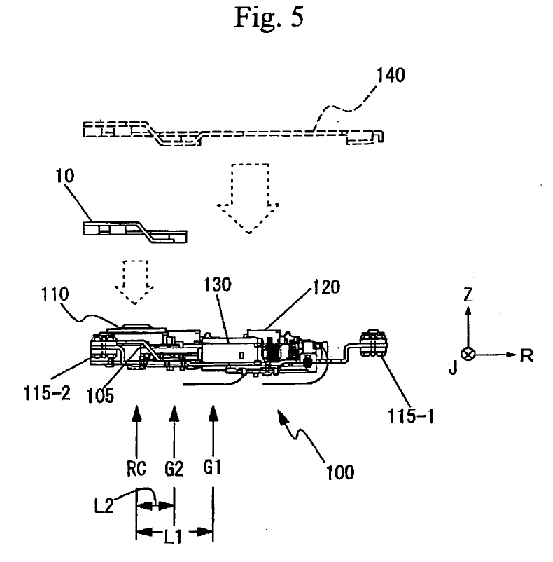

FIG. 5 shows how the weight 10 is installed in the disk drive main body 100. For the purpose of comparison, the conventional weight 140 is illustrated by the broken line. As shown in FIG. 5, the weight 10 is disposed on the periphery of an area in which the rotation drive mechanism 110 for rotating the disk 1 exists. The area in which the weight 10 is disposed is opposite to an area in which the optical pickup unit 120 and the moving mechanism 130 are disposed. More particularly, the weight 10 is disposed so that the center of gravity of the weight 10 is opposite, via the rotational axis of the rotation drive mechanism 110, to a side in which the initial center-of-gravity position of the chassis 105 that includes and actually supports the rotation drive mechanism 110, the optical pickup unit 120 and the moving mechanism 130.

A further description will now be given of the arrangement of the weight 10. As has been described previously, the rotation drive mechanism 110 for rotating the disk 1 is arranged on the end of the disk drive main body 100 for the purpose of downsizing. Further, the optical pickup unit 120 is provided so as to move within the central area of the chassis 105, and the moving mechanism 130 for moving the pickup unit 120 is arranged next to the unit 120. As is shown in FIG. 5, the above arrangement results in a large distance L1 between the position G1 of the center of gravity of the drive main body 100 and the rotational center RC of the disk 1. Thus, the arrangement boosts vibration caused by rotation of the disk 1.

In the prior art, attention is paid to increasing the weight of the chassis 105 in order to restrain vibration. That is, the weight 140 is used to merely increase the weight of the chassis 105 without considering the position of the center of gravity (initial center-of-gravity position) of the whole chassis 105. If uncontrollable vibration occurs due to rotation of the disk 1, it may cause boosted vibration and noise that travel to the outside of the disk drive.

Taking the above into consideration, according to the present embodiment, the weight 10 is mounted on the chassis 105 so that the position of the center of gravity of the chassis 105 with the weight 10 being mounted thereon shifts toward the rotation drive mechanism 110. In the present embodiment, the weight 10 is positioned on the chassis 105 in eccentric formation so that the corrected position G2 of the center of gravity of the chassis 105 with the weight 10 being mounted thereon makes a distance L2 that is shorter than the conventional distance L1 and is therefore closer to the rotational center RC of the disk 1 than the conventional position G1. More particularly, the weight 10 is disposed in a position close to the rotation drive mechanism 110 in which position the optical pickup unit 120 and the associated moving mechanism 130 do not exist. This positioning of the weight 10 allows the initial center-of-gravity position G1 in the absence of the weight 10 to shift toward the rotational center RC by (L1-L2). The position of the weight 10 and the degree of (L1-L2) may be suitably adjusted on the individual disk drive basis. More preferably, the distance L1 is zero (L2=0). It is also preferable that the center of gravity of the weight 10 is positioned opposite, via the rotational axis of the rotation drive mechanism 110, to the initial center-of-gravity position of the chassis 105 that includes the rotation drive mechanism 110, the optical pickup unit 120 and the moving mechanism 130, so that the corrected center-of-gravity position G2 of the chassis 105 that includes the components 110, 120 and 130 and the weight 10 can coincide with the rotational axis.

Since the corrected center-of-gravity position G2 is close to the rotational center RC or is positioned thereon, it is possible to prevent vibration caused by rotation of the disk 1 from being boosted. The distance L2 between the corrected center-of-gravity position G2 and the rotational center RC of the disk 1 becomes close to or equal to zero, so that vibration can be restrained without being boosted. In the present embodiment, the weight of the weight 10 is efficiently and effectively utilized, so that the weight 10 may be lighter than the conventional weight 140. Thus, the weight 10 may be fixed to the chassis 105 by a reduced number of assembling steps. Further, the whole weight of the disk drive can be reduced, this resulting in cost reduction in transport.

Now, influence of vibration caused in the disk drive main body 100 will further be considered. As shown on the right side of FIG. 5, directions J, R and Z are defined. The directions Z are directions perpendicular to the disk drive main body 100. The directions R are directions in which the optical pickup unit 120 moves. The directions J are width directions of the main body 100. When the disk drive vibrates, a chassis vibration in the Z directions perpendicular to the disk surfaces will and another chassis vibration in the R directions in which the optical pickup unit 120 moves cause more considerable problems than a vibration in the J directions.

The present inventor prepared the embodiment disk drive in which the weight 10 is mounted on the disk drive main body 100 shown in FIG. 5, and the comparative disk drive in which the weight 140 is mounted on the disk drive main body 100 shown in FIG. 5. Vibrations caused in the disk drive main bodies 100 were observed by measuring accelerations (m/s²) in the R, Z and J directions. Acceleration sensors associated with the R, Z and J directions were attached to the disk drive main bodies 100. The measurement was conducted ten times for each of the two disk drives, and the average values and standard deviations σ were calculated. The calculated results are shown in Tables 1 and 2. Table 1 shows acceleration data obtained for the comparative disk drive, and Table 2 shows acceleration data obtained for the embodiment disk drive.

TABLE 1

| No of Times | Z Direction | R direction | J direction |
|---|---|---|---|
| 1 | 5.606 | 6.586 | 3.567 |
| 2 | 5.782 | 6.390 | 3.587 |
| 3 | 5.449 | 6.468 | 8.036 |
| 4 | 3.744 | 6.311 | 7.487 |
| 5 | 4.292 | 6.742 | 7.487 |
| 6 | 5.272 | 6.703 | 6.899 |
| 7 | 4.390 | 6.664 | 1.735 |
| 8 | 5.743 | 6.233 | 6.233 |
| 9 | 5.351 | 6.664 | 6.978 |
| 10 | 5.782 | 5.998 | 7.487 |
| Average | 5.141 | 6.476 | 5.950 |
| σ | 0.730 | 0.242 | 2.173 |

TABLE 2

| No of Times | Z Direction | R direction | J direction |
|---|---|---|---|
| 1 | 5.841 | 5.488 | 2.548 |
| 2 | 5.331 | 5.488 | 1.695 |
| 3 | 5.096 | 5.880 | 2.058 |
| 4 | 5.214 | 5.410 | 1.784 |
| 5 | 4.861 | 5.527 | 1.980 |
| 6 | 5.527 | 5.527 | 1.676 |
| 7 | 4.900 | 5.723 | 1.754 |
| 8 | 4.547 | 5.723 | 1.578 |
| 9 | 5.645 | 6.076 | 1.891 |
| 10 | 5.292 | 5.645 | 1.823 |
| Average | 5.225 | 5.649 | 1.879 |
| σ | 0.391 | 0.207 | 0.276 |

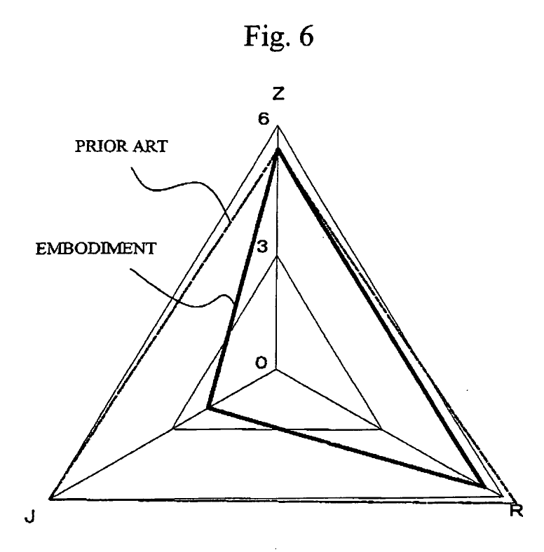

FIG. 6 shows the average values of the disk devices in the R, Z and J directions obtained from Tables 1 and 2. In FIG. 6, the smaller the average value in each direction, the less vibration caused. The disk drive according to the present embodiment has less vibration in the Z directions than that of the comparative disk drive. It is to be noted that vibration in the Z directions particularly affects the disk drive. It can be seen from the above that the weight 10 used in the present embodiment is compact as compared to the conventional weight 140, nevertheless the weight 10 brings about marked effects.

It should also be noted that improvement is observed in the R directions according to the present embodiment. The optical pickup unit 120 moves in the R directions, and vibration in these directions affects positioning of the unit 120. Reduced vibration in the R directions contributes to improving the accuracy in reproduction and recording. Much more improvement is observed in the J directions according to the present invention. However, vibration in the J directions will not affect the disk drive as much as vibrations in the Z and R directions.

The disk drive according to the present embodiment employs a simple means for mounting the compact weight 10 in the offset position on the side of the rotation drive mechanism. This simple means effectively restrains vibration resulting from disk rotation. Since the weight is comparatively compact, the number of assembling steps can be reduced and the weight of the disk drive can be reduced.

The weight 10 shown in FIGS. 4A through 4D is a single-piece member. However, the weight 10 may be composed of two or more separate pieces, which are mounted on the chassis, and similar effects can be provided. The dumping abilities of the four dumpers 115-1 through 115-4 may be adjusted. For example, the dumpers 115-2 and 115-3 provided on the side of the rotation drive mechanism 110 may be designed to have stronger dumping abilities than the remaining dumpers 115-1 and 115-4. The disk drive may be fixed to the casing at three points rather than four points.

The present invention is not limited to the specifically disclosed embodiments, and variations and modifications may be made without departing from the scope of the present invention mentioned before.

The disk drive according to the present invention has a simple structure of mounting the compact weight in the offset position on the side of the rotation drive mechanism. This simple structure effectively restrains vibration resulting from rotation of the disk. Since the weight is comparatively compact, the number of assembling steps can be reduced and the weight of the disk drive can be reduced.

The present invention is based on Japanese Patent Application No. 2002-289409, the entire disclosure of which is hereby incorporated by reference.

What is claimed is:

1. A disk drive comprising:
a rotation drive mechanism that rotates a disk;
an optical unit that records information on the disk and/or reproduces information therefrom;
a moving mechanism that moves the optical unit;
a chassis that supports the rotation drive mechanism, the optical unit and the moving mechanism; and
a weight positioned opposite, via a rotational axis of the rotation drive mechanism, to an initial center-of-gravity position of the chassis that includes the rotation drive mechanism, the optical unit and the moving mechanism.

2. The disk drive as claimed in claim 1, wherein the weight is arranged on a side of the rotation drive mechanism opposite, via the rotational axis, to the optical unit and the moving mechanism.

3. The disk drive as claimed in claim 1, wherein the weight is attached to a part of a periphery of the chassis.

4. The disk drive as claimed in claim 1, wherein the weight has a shape that matches a shape of a part of the chassis.

5. The disk drive as claimed in claim 1, wherein the weight is a single-piece member.

6. The disk drive as claimed in claim 1, wherein the weight comprises at least two pieces.

7. The disk drive as claimed in claim 1, wherein the chassis is equipped with dumpers for vibration isolation.

8. The disk drive as claimed in claim 1, wherein a corrected center-of-gravity position of the chassis with the weight being mounted thereon substantially coincides with the rotational axis.
